(19) United States
(12) Patent Application Publication
(10) Pub. No.: US 2026/0252395 A1
(43) Pub. Date: Aug. 27, 2026

(54) EXECUTION SUPPORT DEVICE, EXECUTION SUPPORT METHOD, AND STORAGE MEDIUM

(71) Applicant: NEC Corporation, Tokyo (JP)

(72) Inventors: Hirofumi UEDA, Tokyo (JP); Shunichi Kinoshita, Tokyo (JP); Tomohiko Yagyu, Tokyo (JP); Ryo Mizushima, Tokyo (JP); Shota Kizukuri, Tokyo (JP); Takahisa Yutoku, Tokyo (JP); Kazutoshi Koike, Tokyo (JP); Koya Ozaki, Tokyo (JP)

(73) Assignee: NEC Corporation, Tokyo (JP)

(21) Appl. No.: 19/434,462

(22) Filed: Dec. 29, 2025

(30) Foreign Application Priority Data
Feb. 25, 2025 (JP) 2025-028341

(51) Int. Cl. G06F 9/50

(52) U.S. Cl. CPC G06F 9/5027

(57) ABSTRACT

An execution support device according to an aspect of the present disclosure includes: at least one memory storing a set of instructions; and at least one processor configured to execute the set of instructions to: receive a request for a procedure of processing on a target; specify a target task by using a model that specifies the target task, from history information and a target request that is the received request, among a plurality of tasks each of which includes an individual task, the history information including information indicating a task on which execution has been completed in the processing; derive a procedure of executing a target individual task from information of the target task and already obtained information in information of the target, the target individual task being the individual task to be executed next in the individual task included in the target task; and present the procedure.

This application is based upon and claims the benefit of priority from Japanese Patent Application No. 2025-028341, filed on February 25, 2025, the disclosure of which is incorporated herein in its entirety by reference.

### TECHNICAL FIELD

The present disclosure relates to an execution support device, an execution support method, and a storage medium.

### BACKGROUND ART

A large language model (LLM) has come into use in various contexts. “PentestGPT: An LLM-empowered Automatic Penetration Testing Tool” (Gelei Deng et al., [online], August 13, 2023, Cornell University, [retrieved on January 6, 2025], Internet <URL: https://arxiv.org/abs/2308.06782>) discloses an example of a penetration test using the LLM.

In the example of “PentestGPT: An LLM-empowered Automatic Penetration Testing Tool” (Gelei Deng et al., [online], August 13, 2023, Cornell University, [retrieved on January 6, 2025], Internet <URL: https://arxiv.org/abs/2308.06782>), a system operates by an analysis module that analyzes an instruction of a user, execution of a security tool or the like, and a result of a user operation, an inference module that determines a next task based on a result of the analysis and a task tree, and a generation module that generates a processing content from the determined task.

### SUMMARY

In the technique of “PentestGPT: An LLM-empowered Automatic Penetration Testing Tool” (Gelei Deng et al., [online], August 13, 2023, Cornell University, [retrieved on January 6, 2025], Internet <URL: https://arxiv.org/abs/2308.06782>), the inference module based on LLM determines a next task based on a result of analysis and a task tree. However, it cannot be said that the LLM can understand a complicated operation such as execution of processing including a plurality of tasks each including a subtask, and can normally appropriately control the progress. The same applies to the inference module of “PentestGPT: An LLM-empowered Automatic Penetration Testing Tool” (Gelei Deng et al., [online], August 13, 2023, Cornell University, [retrieved on January 6, 2025], Internet <URL: https://arxiv.org/abs/2308.06782>).

An object of the present disclosure is to provide an execution support device, an execution support method, and a program capable of improving the appropriateness of control of the progress of complicated processing.

An execution support device according to an aspect of the present disclosure includes: at least one memory storing a set of instructions; and at least one processor configured to execute the set of instructions to: receive a request for a procedure of processing on a target; specify a target task by using a model that specifies the target task, from history information and a target request that is the received request, among a plurality of tasks each of which includes an individual task, the target task being a task to be performed next, the history information including information indicating a task on which execution has been completed in the processing, the plurality of tasks achieving the processing; derive a procedure of executing a target individual task from information of the target task and already obtained information in information of the target, the target individual task being the individual task to be executed next in the individual task included in the target task; and present the procedure.

An execution support method according to an aspect of the present disclosure includes: receiving a request for a procedure of processing on a target; specifying a target task by using a model that specifies the target task, from history information and a target request that is the received request, among a plurality of tasks each of which includes an individual task, the target task being a task to be performed next, the history information including information indicating a task on which execution has been completed in the processing, the plurality of tasks achieving the processing; deriving a procedure of executing a target individual task from information of the target task and already obtained information in information of the target, the target individual task being the individual task to be executed next in the individual task included in the target task; and presenting the procedure.

A non-transitory computer readable storage medium according to an aspect of the present disclosure stores a program for causing a computer to execute: receiving processing of receiving a request for a procedure of processing on a target; specifying processing of specifying a target task by using a model that specifies the target task that is a task to be performed next, from history information including information indicating a task on which execution has been completed in the processing among a plurality of tasks that implement the processing and each include an individual task and a target request that is the received request; procedure deriving processing of deriving a procedure of executing a target individual task that is an individual task to be executed next among individual tasks included in the target task, from information of the target and information of the target task, which have been already obtained; and presentation processing of presenting the procedure.

The present disclosure has an effect that it is possible to improve the appropriateness of progress control of complicated processing.

### BRIEF DESCRIPTION OF THE DRAWINGS

FIG. 1 is a block diagram illustrating an example of a configuration of an execution support device according to the present disclosure;

FIG. 2 is a flowchart illustrating an example of an operation of the execution support device according to the present disclosure;

FIG. 3 is a block diagram illustrating an example of a configuration of an execution support device according to the present disclosure;

FIG. 4 is a flowchart illustrating an example of the entire operation of the execution support device according to the present disclosure;

FIG. 5 is a flowchart illustrating an example of an operation of request execution processing of the execution support device according to the present disclosure;

FIG. 6 is a flowchart illustrating the example of the operation of the request execution processing of the execution support device according to the present disclosure; and

FIG. 7 is a diagram illustrating an example of a hardware configuration of a computer capable of implementing the execution support device.

### EXAMPLE EMBODIMENT

Hereinafter, example embodiments of the present disclosure will be described in detail with reference to the drawings. In the drawings of the present disclosure, elements with which information is exchanged are linked by solid lines. However, the elements with which information is exchanged are not limited to the elements linked by solid lines.

### First Example Embodiment

First, a first example embodiment of the present disclosure will be described in detail with reference to the drawings.

### Configuration

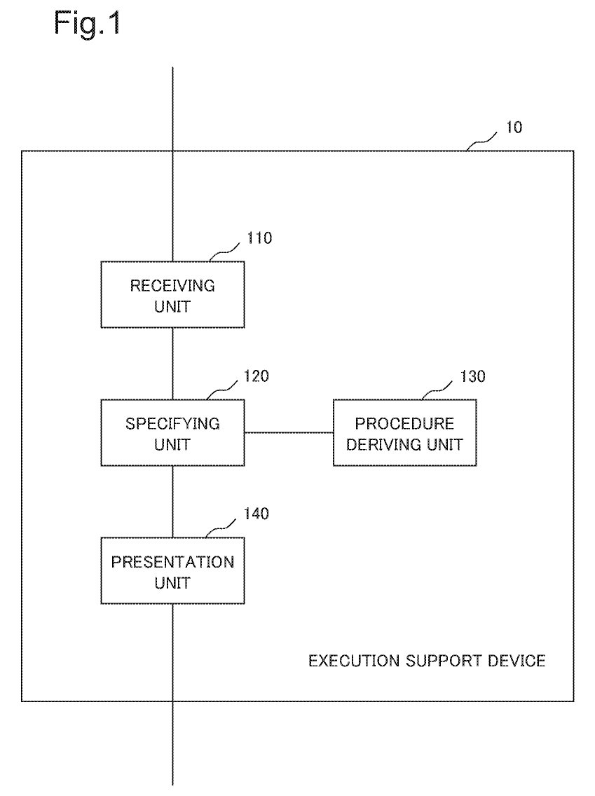

FIG. 1 is a block diagram illustrating an example of a configuration of an execution support device according to the present disclosure.

Hereinafter, the configuration of the execution support device according to the first example embodiment of the present disclosure will be described in detail with reference to FIG. 1.

In the example illustrated in FIG. 1, an execution support device 10 includes a receiving unit 110, a specifying unit 120, a procedure deriving unit 130, and a presentation unit 140.

The receiving unit 110 receives a request for a procedure of processing on a target.

The specifying unit 120 specifies a target task that is a task to be performed next, by using a model. The model specifies a target task from history information including information indicating a task on which execution has been completed in processing and a target request which is a received request, among a plurality of tasks for implementing processing. Each of the plurality of tasks includes an individual task. The model will be described in detail later.

The procedure deriving unit 130 derives a procedure of executing a target individual task that is an individual task to be executed next among individual tasks included in the target task, from information of the target and information of the target task, which have already been obtained.

The presentation unit 140 presents a procedure.

### Receiving Unit 110

As described above, the receiving unit 110 receives a request for a procedure of processing on a target.

The target is a target of processing. Specifically, the target is an object or information as a target of processing, such as hardware, software, or electronic data. More specifically, the target is, for example, an information processing apparatus or an information processing system. The processing is, for example, an investigation of vulnerability. The request is, for example, a text that describes requiring a procedure of performing processing on the target. The request includes a text representing an action and a text representing processing.

The target and the processing are not limited to this example. For example, the target may be software or a document.

The processing is implemented by a plurality of partial processes each of which is at least a part of the processing. Further, each of the partial processes is implemented by an individual process that is at least a part of the partial process. In the description of the example embodiments of the present disclosure, the partial process is referred to as a task. The individual process is referred to as an individual task. It can be said that the processing is implemented by a group of tasks that is at least a part of the processing. It can be said that the task is a set of individual tasks that are at least a part of the task. In this case, the processing is represented by a tree structure in which the processing is a root node, each task is a node connected to the root node at an edge, and each individual task is a node connected to the node of the task at an edge. A task and an individual task that implement processing represented by a tree structure are referred to as a task tree. In the example embodiments of the present disclosure, in the task tree, an order is determined for a task (a task connected to a root node or an individual task connected to a node that is a task) relevant to a node connected to the same node by an edge. The task relevant to a node connected to the same node by an edge is, for example, a task relevant to a node connected to a root node or an individual task relevant to a node connected to a node that is a task.

In a case where the target is an information processing apparatus, an information processing system, or the like and the processing is an investigation of vulnerability, the task is, for example, an investigation of the target, an investigation of known vulnerability, or an investigation of a detailed state. In this case, the investigation of the target includes, for example, an investigation of a valid port, an investigation of a valid service, and an investigation of an operating system as individual tasks. The investigation of the known vulnerability may include an investigation of vulnerability as an individual task. In this case, the individual task included in a task of the investigation of the known vulnerability is only the investigation of vulnerability. The investigation of the known vulnerability may include, as individual tasks, an investigation of vulnerability of an operating system and an investigation of vulnerability of each of a plurality of pieces of software. The investigation of the detailed state may include an investigation of each of predetermined items as an individual task. The investigation of the predetermined item may include, for example, an investigation of a predetermined port and a service of a protocol using the port, an investigation of a predetermined type of setting, and an investigation of a predetermined type of information. The predetermined type of setting is, for example, a setting that increases the possibility of an occurrence of an event related to security (information leakage, success of attack from outside, and the like). The predetermined type of information is, for example, information of the type of encryption used or information of the type of certificate used, and the like. The investigation of the predetermined item may include, for example, an investigation of whether the target is in a predetermined state. The predetermined state is, for example, a state in which a back door exists, or a state in which information leakage has occurred.

In a case where the target is software, the processing is, for example, development of the software. In this case, the task is, for example, requirement definition, basic design, or detailed design, in a development flow. The individual task is a more detailed process executed in each task. Specifically, the individual task is, for example, detection of an incomplete item in each stage such as requirement definition, basic design, and detailed design. The procedure is, for example, a procedure for detecting an incomplete item.

In a case where the target is a document, the processing is, for example, an inspection of the document. In this case, the task is, for example, an inspection for each inspection item of the document. Examples of the inspection item include an inspection of a format, an inspection of description omission, and an inspection of an erroneous description. The individual tasks include, for example, individual tasks that perform each of various inspections. The procedure is a procedure of executing each inspection. The individual task may include, for example, an individual task that corrects incompletion found by the inspection. The procedure in this case may be a correction instruction.

Examples of the target, the task, and the individual task are not limited to the above examples.

The processing on the target may be processing started from now. The processing on the target may be processing that has been already started (in other words, processing being executed).

The request for a procedure of processing on a target is input as text, for example. In other words, the request for a procedure of processing on a target may be, for example, text data. The request for a procedure of processing on a target may be data in another format that can be recognized by the receiving unit 110.

### Specifying Unit 120

As described above, the specifying unit 120 specifies a target task that is a task to be performed next, by using a model. The model specifies a target task from history information including information indicating a task on which execution has been completed in processing and a target request which is a received request, among a plurality of tasks for implementing processing. Each of the plurality of tasks includes an individual task. The model is, for example, a large language model. The large language model is, for example, a program (so-called generative artificial intelligence (AI)) that extracts feature amounts of language and context from a large amount of text data and has learned the appearance probability of a word, by machine learning such as deep learning. In the description of example embodiments of the present disclosure, the large language model may be referred to simply as a model.

As described above, the processing on the target may be processing started from now. The processing on the target may be processing that has been already started (in other words, processing being executed). In a case where the processing on the target is processing that has been already started (in other words, the processing being executed), a procedure of executing an individual task included in any of tasks for implementing the processing has already been output. The history information includes information of a task that has already ended among tasks for implementing processing. The history information may include information of a task being executed (that is, a task that has been started and has not ended). The history information may include information indicating an individual task for which the procedure has already been output.

As described above, in the example embodiments of the present disclosure, a task refers to a set of individual tasks included in the task. Execution of a task means that any of individual tasks included in the task is executed. Execution of an individual task means that an operation indicated by a procedure of executing the individual task is performed by a user. Specifically, a task to be executed next means a task including an individual task to be executed next.

The procedure is information representing the content of work performed by the user to execute an individual task. The content of the work may be, for example, a character string representing a command to be executed. The command in this case may be, for example, a character string representing a command, an option, an argument, and the like input to a command prompt. The content of the work may be, for example, a character string for describing work to be executed. The content of the work may be, for example, a character string for describing an operation on an application program for executing an individual task. The character string and the like may include a character string, a figure, an image, and a mark. An environment (for example, the type of OS of an information processing apparatus in which a command is executed, or the type of application program for executing an individual task) in which a procedure is executed is given to the execution support device 10 in advance.

For example, the specifying unit 120 specifies processing for which a procedure is requested and a target of the processing from a request for the procedure of the processing on the target, which has been received by the receiving unit 110. The specifying unit 120 may specify a target on which processing is to be performed, and the processing from text representing the request by using the model. Specifically, the specifying unit 120 generates an instruction to specify a target on which processing is to be performed, and the processing from the text representing the request. The specifying unit 120 inputs the generated instruction and the request to the model. In accordance with the input instruction, the model generates information (for example, text data) representing the target on which the processing is to be performed, and the processing from the request. The specifying unit 120 receives, from the model, the information representing the target on which the processing is to be performed, and the processing. Such information is output by the model. The specifying unit 120 specifies the target on which the processing is to be performed, and the processing from the information received from the model. The specifying unit 120 may specify the processing for which the procedure is requested and the target of the processing from the text representing the request by using a language recognition technique.

A task (for example, a plurality of tasks) for implementing processing is determined in advance for each type of processing. An individual task included in each of a plurality of tasks is also determined in advance. The order of executing a plurality of tasks for implementing processing is determined in advance.

In each of a plurality of tasks, a basic order in which individual tasks are executed (referred to as a basic order) is also determined in advance. The basic order is an order determined in advance as an order in which individual tasks are executed in each of a plurality of tasks. The individual task from which the procedure is derived by the procedure deriving unit 130 to be described in detail later is not necessarily the same as the individual task to be executed next in a case where the individual task is executed in the basic order.

Information of the order of executing a plurality of tasks for implementing processing is referred to as order information.

Information of the basic order in which individual tasks in each of a plurality of tasks are executed is referred to as individual order information. The order information may include the individual order information.

For example, the specifying unit 120 may specify, as a target task, a task to be executed next to a task to be executed most recently in order information representing an order in which tasks are executed in processing, among ended tasks among a plurality of tasks for implementing the processing, which is indicated by the history information. For example, in a case where a task is executed in accordance with an order indicated by the order information, and each individual task of the task is executed in accordance with an order indicated by the individual order information, the specifying unit 120 may specify a task that has been executed most recently among individual tasks (indicated by the history information) for which the procedure has been output. In a case where a task is executed in the order indicated by the order information, and each individual task of the task is executed in the order indicated by the individual order information, a task including an individual task to be executed next to the specified task may be specified as a target task to be executed next.

The specifying unit 120 may specify a task to be executed next by using a model (also referred to as an order control model) configured to be able to output the task to be executed next. In this case, the specifying unit 120 first inputs order information of the specified processing and history information to the order control model. The specifying unit 120 inputs an instruction to specify the task to be executed next to the order control model. The specifying unit 120 receives, from the order control model, information of the task to be executed next, which is specified by the order control model. The specifying unit 120 specifies the task to be executed next, which is indicated by the information received from the order control model, as a target task that is a task to be executed next.

Order information of various types of processing may be input in the order control model in advance. In this case, the specifying unit 120 inputs, for example, history information of the specified processing, information representing the specified processing, and an instruction to specify a task to be executed next in the processing to the order control model. Then, the specifying unit 120 receives, from the order control model, information of the task to be executed next, which is specified by the order control model.

The order control model may be implemented in an information processing apparatus different from the execution support device 10. The order control model may be implemented in the execution support device 10.

### Procedure Deriving Unit 130

As described above, the procedure deriving unit 130 derives a procedure of executing a target individual task that is an individual task to be executed next among individual tasks included in the target task, from information of the target and information of the target task, which have already been obtained.

Information of a task may include, for example, information indicating an individual task included in the task, information of a basic order representing a basic order of executing the individual task, information of a procedure for executing the individual task, and information indicating a type of information obtained by executing the individual task. The information of the task may include information indicating a type of information (also referred to as an acquisition information type) obtained by executing the task, that is, information indicating a type of information (also referred to as an individual acquisition information type) obtained by executing all of individual tasks included in the task.

For example, the procedure deriving unit 130 specifies a type (referred to as a not-acquisition information type below) of information that is not included in the already-obtained information of the target among acquisition information types. For example, the procedure deriving unit 130 derives, as an individual task to be executed next, an individual task that is executed in the earliest order in the basic order among individual tasks of which the individual acquisition information type is included in the not-acquisition information type. In other words, the individual task in which the individual acquisition information type is included in the not-acquisition information type is an individual task capable of acquiring any piece of information of the not-acquisition information type by execution.

The procedure deriving unit 130 derives a procedure for executing an individual task (that is, the target individual task) to be executed next from information of the procedure for executing the individual task, which is included in the information of the task. The procedure information may include, for example, information representing a procedure (for example, a command or an operation) for executing each of individual tasks included in the target task for each of various targets. The information of the procedure for executing the individual task, which is included in the information of the task, does not include information indicating a target on which the individual task is executed. The procedure deriving unit 130 generates a procedure for executing an individual task on a target from the information indicating the target and the information of the procedure for executing the individual task, which is included in the information of the task. In the information of the procedure for executing the individual task, which is included in the information of the task, a part of the information indicating the target on which the individual task is executed may be information indicating that the part is replaced with information indicating the target. In this case, the procedure deriving unit 130 generates the procedure for executing the individual task on the target by replacing, with the information indicating the target, the information indicating that the part is to be replaced with the information indicating the target in the information of the procedure for executing the individual task, which is included in the information of the task.

The information of the procedure may include information of a procedure of executing an individual task for each predetermined environment in which the procedure is executed. The procedure deriving unit 130 may generate a procedure for executing the individual task on the target by using the information of the procedure for executing the target individual task in the environment of a user who has input a request among pieces of the information of the procedure.

The procedure deriving unit 130 may derive a procedure for executing the target individual task from the information of the target and the information of the target task by using a task model configured to be able to output a procedure for executing the individual task included in the target task that is the specified task among a plurality of task models. Each of the plurality of task models is a model configured to be able to output a procedure of execution of an individual task of one task among a plurality of tasks. Each of the task models may be a large language model.

Each of the plurality of task models is configured to be able to output a procedure of executing an individual task included in one task among a plurality of tasks. The tasks in which each of the plurality of task models can output the procedure of executing the individual task may be different.

The task model configured to be able to output the procedure of executing the individual task included in the target task is, for example, a model to which information of the procedure of executing the individual task is given for each of individual tasks included in the target task. As described above, the procedure information may include, for example, information representing a procedure (for example, a command or an operation) for executing each of individual tasks included in the target task for each of various targets. The information of the procedure for the individual task included in the target task may be given to the task model in advance. The procedure deriving unit 130 may give the information of the procedure for the individual task included in the target task to the task model.

The procedure deriving unit 130 gives the information of the target to the task model configured to be able to output the procedure for executing the individual task included in the target task. The information of the target includes, for example, information for specifying the target. The information of the target may include information for specifying the target and information regarding the target, which has been already obtained. The information regarding the target is, for example, information of a state of at least a part of the target. The procedure deriving unit 130 inputs, for example, a generation instruction to generate a procedure for executing a target individual task that is an individual task to be performed next, to a task model configured to be able to output a procedure for executing an individual task included in the target task.

In response to the input of the generation instruction, the task model generates the information of the procedure for executing the target individual task in the processing on the target, by using the information of the target and the information of the procedure for the individual task included in the target task. The task model outputs the generated information of the procedure to the procedure deriving unit 130.

The information of the target may include information of a target part of the individual task of the target task, which exists in the target. The target part of the individual task is, for example, a part of the target, which is accessed by processing by the individual task. In a case where the target is an information processing apparatus, the target part may be, for example, a port, a memory area in which a program operating in the information processing apparatus is loaded, or a storage medium or a memory in which setting information in the information processing apparatus is recorded. The target part is not limited to these examples. In a case where the individual task is a task of performing certain investigation, confirmation, or the like, the target part is relevant to a part where the investigation, confirmation, or the like is performed by the individual task. In a case where the individual task is a task of performing certain change, the target part is relevant to a part to be changed by the individual task. The information of the target may be information representing the presence or absence of the target part of the individual task existing in the target. Such information of the target may be information obtained as a result of executing the individual task. The procedure deriving unit 130 may exclude the type of information obtained from the target part of the individual task that does not exist in the target, from the above-described not-acquisition information type.

The task model may determine an individual task to be executed next by using the information of the target, the information of the target task (for example, information of the individual task included in the target task), and the information of a procedure for the individual task included in the target task. The information of the individual task may include information of the target part of the individual task. Specifically, for example, the task model may exclude an individual task that is not executed from individual tasks that are included in the target task and have not yet been executed. The individual task that is not executed may be, for example, an individual task in which the target part does not exist in the target. The individual task that is not executed may be, for example, an individual task in which the information regarding the target obtained by execution has already been obtained. The task model may determine, as an individual task to be executed next, an individual task having the earliest order of execution among individual tasks that are included in the target task, have not been executed yet, and have not been excluded. In this case, upon receiving the above-described generation instruction, the task model generates a procedure for executing an individual task to be executed next after determining the individual task to be executed next.

Each of a plurality of task models operates similarly to the above-described task model. A task including the individual task executed by the procedure generated by each of the plurality of task models is one of the plurality of tasks described above. One of the plurality of task models is prepared for each of the plurality of tasks. For example, each of the plurality of tasks is associated with a different one of the plurality of task models. In other words, each of the plurality of tasks is associated with one of the plurality of task models. The task model associated with each of the plurality of tasks is different for each task. Each task model of the plurality of task models generates a procedure for an individual task of a task associated with this task model. Each task model of the plurality of task models may determine an individual task to be executed next among individual tasks of a task associated with this task model, and generate a procedure for the determined individual task.

One procedure deriving unit 130 may input the generation instruction to the task model associated with the task including the individual task to be executed next. In this case, for example, one different task model is associated with each of the plurality of tasks. In other words, the task model associated with each of the plurality of tasks is different for each task.

A different procedure deriving unit 130 may exist for each of the plurality of task models. In this case, one different combination of the procedure deriving unit 130 and the task model may be associated with each of the plurality of tasks. In other words, in this case, one procedure deriving unit 130 and one task model are associated with each of the plurality of tasks. The procedure deriving unit 130 and the task model associated with each of the plurality of tasks are different for each task.

In this case, the specifying unit 120 transmits a derivation instruction that is an instruction to derive a task for executing an individual task to be performed next, to the procedure deriving unit 130 associated with a target task that is a task including a target individual task to be performed next. The procedure deriving unit 130 that has received the derivation instruction derives a procedure for executing an individual task to be performed next, by using the task model associated with the procedure deriving unit 130.

### Presentation Unit 140

As described above, the presentation unit 140 presents the derived procedure.

For example, the presentation unit 140 may output information representing a procedure to a terminal device used by the user. The presentation unit 140 may output the information representing the procedure to AI (specifically, an information processing apparatus in which a program for implementing such AI operates) that interprets the received information representing the procedure and executes the procedure. In this case, specifically, the presentation unit 140 may output the information representing the procedure, as an input to the AI, to an information processing apparatus in which the program for implementing the AI that interprets the received information representing the procedure and executes the procedure operates. The terminal device is a terminal device such as an information processing apparatus used by the user, which is communicatively connected to the execution support device 10. For example, the presentation unit 140 may display the information representing the procedure on a display or the like of the execution support device 10. The information representing the procedure may be, for example, text representing the procedure. The information representing the procedure may be, for example, a character string or an image.

The presentation unit 140 may present the information representing the procedure and supplementary explanation such as “please execute next command”, for example. The supplementary explanation may be any of instructions, cautions, reference information, and the like regarding the procedure to be presented. The supplementary explanation is not limited to this example.

### Operation

Next, an operation of the first example embodiment of the present disclosure will be described in detail with reference to the drawings.

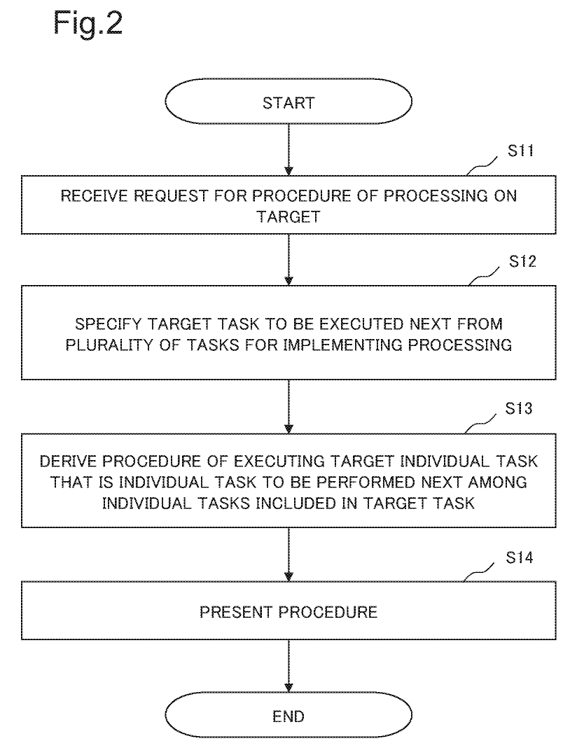

FIG. 2 is a flowchart illustrating an example of an operation of the execution support device according to the present disclosure.

Hereinafter, the operation of the execution support device according to the first example embodiment of the present disclosure will be described in detail with reference to FIG. 2.

In the example illustrated in FIG. 2, the receiving unit 110 receives a request for a procedure of processing on a target (Step S11). The specifying unit 120 specifies a target task including a target individual task that is an individual task to be performed next among a plurality of tasks, each including individual tasks (Step S12). The procedure deriving unit 130 derives a procedure of executing the target individual task by using a task model that outputs a procedure of executing the individual task of the target task (Step S13). The presentation unit 140 presents the procedure (Step S14).

### Effects

The present example embodiment described above has an effect that it is possible to improve the appropriateness of control of the progress of complicated processing.

This is because the specifying unit 120 specifies a target task that is a task to be executed next among a plurality of tasks including individual tasks by using a model that specifies a target task that is a task to be executed next. This is because the procedure deriving unit 130 derives a procedure of executing a target individual task that is an individual task to be executed next among individual tasks included in the target task from the information of the target and the information of the target task.

As described above, it cannot be said that a model (for example, LLM or another model) can generally understand a complicated operation such as execution of processing including a plurality of tasks each including a subtask, and can normally appropriately control the progress thereof. However, by limiting a range in which one model performs control to a part of a complicated operation, the appropriateness of control of the progress of the part of the operation by the model is improved. In the present example embodiment, the specifying unit 120 specifies a target task that is a task to be executed next among a plurality of tasks including individual tasks by using a model that specifies a target task that is a task to be executed next. In other words, the range of processing by the model used for specifying the target task to be executed next is limited to specifying the target task that is a part of the processing. Therefore, it is expected that the appropriateness of the progress of the target task is improved. Therefore, the present example embodiment described above has an effect that it is possible to improve the appropriateness of control of the progress of complicated processing.

### Second Example Embodiment

Next, a second example embodiment of the present disclosure will be described in detail with reference to the drawings.

### Configuration

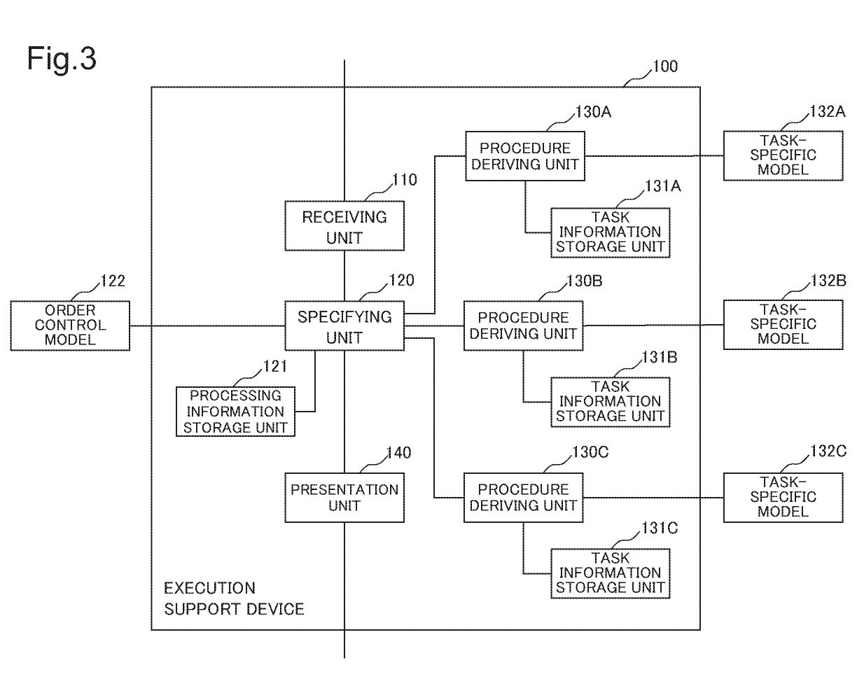

FIG. 3 is a block diagram illustrating an example of a configuration of an execution support device according to the present disclosure.

Hereinafter, the configuration of the execution support device according to the second example embodiment of the present disclosure will be described in detail with reference to FIG. 3.

In the example illustrated in FIG. 3, an execution support device 100 includes a receiving unit 110, a specifying unit 120, a processing information storage unit 121, a procedure deriving unit 130A, a procedure deriving unit 130B, a procedure deriving unit 130C, a task information storage unit 131A, a task information storage unit 131B, a task information storage unit 131C, and a presentation unit 140.

The receiving unit 110, the specifying unit 120, and the presentation unit 140 in the present example embodiment are the same as the receiving unit 110, the specifying unit 120, and the presentation unit 140 in the first example embodiment except for differences included in the following description.

The specifying unit 120 is communicatively connected to an order control model 122. The order control model 122 is the same as the order control model in the first example embodiment.

The procedure deriving unit 130A, the procedure deriving unit 130B, and the procedure deriving unit 130C are communicatively connected to a task-specific model 132A, a task-specific model 132B, and a task-specific model 132C, respectively.

Each of the task-specific model 132A, the task-specific model 132B, and the task-specific model 132C is the same as the task model in the first example embodiment. In the following description, in a case where it is not necessary to distinguish the task-specific model 132A, the task-specific model 132B, and the task-specific model 132C from each other, the task-specific model 132A, the task-specific model 132B, and the task-specific model 132C are referred to as a task-specific model 132.

The procedure deriving unit 130A, the procedure deriving unit 130B, and the procedure deriving unit 130C are similar to the procedure deriving unit 130 in the first example embodiment. Specifically, the procedure deriving unit 130A, the procedure deriving unit 130B, and the procedure deriving unit 130C are the same as the procedure deriving unit 130 in a case where a different procedure deriving unit 130 exists for each of a plurality of task models in the first example embodiment.

In the example illustrated in FIG. 3, the order control model 122, the task-specific model 132A, the task-specific model 132B, and the task-specific model 132C are implemented in an information processing apparatus that is communicatively connected to the execution support device 100. The order control model 122, the task-specific model 132A, the task-specific model 132B, and the task-specific model 132C may be implemented in different information processing apparatuses. Two or more of the order control model 122, the task-specific model 132A, the task-specific model 132B, and the task-specific model 132C may be implemented in the same information processing apparatus. Any one or more of the order control model 122, the task-specific model 132A, the task-specific model 132B, and the task-specific model 132C may be implemented in the execution support device 100.

In the following description, in a case where it is not necessary to individually specify the procedure deriving unit 130A, the procedure deriving unit 130B, and the procedure deriving unit 130C, the procedure deriving unit 130A, the procedure deriving unit 130B, and the procedure deriving unit 130C are referred to as a procedure deriving unit 130. In a case where it is not necessary to individually specify the task information storage unit 131A, the task information storage unit 131B, and the task information storage unit 131C, the task information storage unit 131A, the task information storage unit 131B, and the task information storage unit 131C are referred to as a task information storage unit 131. In a case where it is not necessary to individually specify the task-specific model 132A, the task-specific model 132B, and the task-specific model 132C, the task-specific model 132A, the task-specific model 132B, and the task-specific model 132C are referred to as a task-specific model 132.

In the example illustrated in FIG. 3, the number of combinations of the procedure deriving unit 130 and the task-specific model is 3. However, the number of combinations of the procedure deriving unit 130 and the task-specific model is not limited to 3. The number of combinations of the procedure deriving unit 130 and the task-specific model may be, for example, the same as the number of tasks. Different combinations of the procedure deriving unit 130 and the task-specific model may be implemented for each task. A different task information storage unit 131 may be implemented for each combination of the procedure deriving unit 130 and the task-specific model. One storage unit may operate as a plurality of task information storage units 131.

### Receiving Unit 110

In the present example embodiment, input of a request for a procedure of processing on a target from a user to the execution support device 100, presentation of a procedure to be executed next from the execution support device 100 to the user, and input of a result obtained by executing the presented procedure from the user to the execution support device 100 are performed in a conversation format, for example. In such exchange between the user and the execution support device 100, exchange for a plurality of pieces of processing on one target may be performed in parallel. This exchange represents, for example, input of a request for a procedure of processing on a target, presentation of a procedure to be executed next from the execution support device 100, and input of a result obtained by executing the presented procedure to the execution support device 100 as described above. A plurality of pieces of processing on a plurality of targets may be exchanged in parallel. Such exchange in the conversation format may be performed between the execution support device 100 and AI (specifically, a program of AI implemented in the information processing apparatus) that interprets information representing a procedure and executes the procedure.

The receiving unit 110 receives a request for a procedure of processing on a target. The receiving unit 110 in the present example embodiment further receives the information representing the result obtained by executing the procedure presented by the presentation unit 140.

The request for the procedure of processing on the target, which is received by the receiving unit 110, and the information representing the result obtained by executing the presented procedure are referred to as input information. In other words, the receiving unit 110 receives input information that is one of the request for the procedure of processing on the target and the information representing the result obtained by executing the presented procedure. The input information may be input as text data. The information representing the result obtained by executing the presented procedure may be text data. The information representing the result obtained by executing the presented procedure does not need to be text data. The information representing the result obtained by executing the presented procedure may be a combination of text data and data that is not text data.

### Specifying Unit 120

The specifying unit 120 determines whether the input information received by the receiving unit 110 is a request for a procedure of processing on a target or information representing a result obtained by executing the presented procedure. The specifying unit 120 may recognize the input information by an existing language recognition technique. The information representing the result obtained by executing the presented procedure includes information for specifying a target on which an individual task is performed by the executed procedure.

In a case where the input information is a request for the procedure of processing on the target, the specifying unit 120 specifies the target and the processing. By using the order control model 122, the specifying unit 120 specifies a target task that is a task to be executed next (specifically, a task including an individual task to be executed next) from order information and history information of the specified processing on the specified target.

The order information may be represented by, for example, the task tree described above. Further, the order information may include a type of information obtained by executing each individual task of a plurality of tasks. The order information is stored in, for example, a knowledge database (DB). The knowledge DB is stored in the processing information storage unit 121. The knowledge DB may include the order information for each of various types of processing. The order information accessed by the specifying unit 120 may include the above-described individual order information that is information of an order of the individual tasks included in the task.

The knowledge DB further stores a relationship between a task and a procedure deriving unit 130 (in other words, the task-specific model 132 accessed by the procedure deriving unit 130) that derives a procedure for an individual task included in the task among a plurality of procedure deriving units 130. In the present example embodiment, the plurality of procedure deriving units 130 are the procedure deriving unit 130A, the procedure deriving unit 130B, and the procedure deriving unit 130C. In a case where one procedure deriving unit 130 is configured to operate as each of the plurality of procedure deriving units 130, the knowledge DB stores a relationship between a task and the task-specific model 132 used for deriving the procedure for the individual task included in the task. Information of the relationship between a task and the procedure deriving unit 130 that derives the procedure of the individual task included in the task among the plurality of procedure deriving units 130 is referred to as correspondence relationship information. The correspondence relationship information may be stored in the knowledge DB as tabular data. In a case where the correspondence relationship information is tabular data, the correspondence relationship information may be referred to as a correspondence table.

As described above, the history information is information including the information of the individual task for which the procedure in the processing on the target has already been output. The history information may store an order in which the procedure for the individual task is output in addition to the information of the individual task in which the procedure in the processing on the target has already been output. The history information is stored in, for example, a diagnosis situation DB. The diagnosis situation DB is stored in the processing information storage unit 121. The diagnosis situation DB may store history information for each combination of the target and the processing.

In the diagnosis situation DB, information of a result obtained by executing the procedure for the output individual task in the processing on the target is stored as a part of the history information, for example.

When specifying a target task including an individual task to be executed next by using the order control model 122, the specifying unit 120 gives (that is, inputs), to the order control model 122, the order information and the history information of the specified processing on the specified target. The specifying unit 120 transmits (that is, inputs) an instruction to specify the target task including the individual task to be executed next to the order control model 122. This instruction may be an instruction by text written in any language.

### Order Control Model 122

The order control model 122 may be a model (for example, a large language model or another model) configured to be able to estimate a target task including an individual task to be executed next by using the order information and the history information of the processing on the target. The individual task to be executed next may be an individual task of which output of the procedure is not indicated by the history information and of which the order indicated by the order information is the earliest among individual tasks included in the plurality of tasks for implementing the processing. The individual task to be executed next may be an individual task in which information of a result obtained by executing a procedure is not included in the history information and of which the order indicated by the order information is the earliest among the individual tasks included in the plurality of tasks for implementing the processing. The individual task to be executed next may be different from the individual task exemplified above. The instruction to specify the target task including the individual task to be executed next may be an instruction to specify the task including the individual task exemplified above. The order control model 122 estimates a target task including an individual task to be executed next by using the input order information and history information of processing on the target, and generates information representing the estimated target task. The order control model 122 outputs the generated information representing the estimated target task to the specifying unit 120.

Then, the specifying unit 120 specifies the procedure deriving unit 130 that derives the procedure for the individual task included in the target task among a plurality of procedure deriving units 130 by using the correspondence relationship information. In other words, the specifying unit 120 specifies the procedure deriving unit 130 associated with the target task in the correspondence relationship information. The specifying unit 120 transmits a derivation instruction instructing the specified procedure deriving unit 130 to derive a procedure of executing an individual task to be executed next. The derivation instruction may be an instruction by text described using one of predetermined languages. The specifying unit 120 receives information indicating the procedure of the target task from the procedure deriving unit 130 as a transmission destination of the derivation instruction. The specifying unit 120 transmits the received information representing the procedure for the target task to the presentation unit 140.

In a case where a notification indicating that the target task has already ended is received from the procedure deriving unit 130 to which the derivation instruction has been transmitted, the specifying unit 120 sets a next task of the target task in the order information as a new target task. The specifying unit 120 specifies the procedure deriving unit 130 that derives a procedure for an individual task included in the new target task among the plurality of procedure deriving units 130 by using the correspondence relationship information. In other words, the specifying unit 120 specifies the procedure deriving unit 130 associated with the new target task in the correspondence relationship information. As described above, the specifying unit 120 transmits a derivation instruction instructing the specified procedure deriving unit 130 to derive a procedure of executing an individual task to be executed next. The specifying unit 120 receives information indicating the procedure of the target task from the procedure deriving unit 130 as a transmission destination of the derivation instruction. The specifying unit 120 transmits the received information representing the procedure for the target task to the presentation unit 140.

In a case where the input information is information representing a result obtained by executing the presented procedure, the specifying unit 120 specifies by which procedure already output the result received as the input information has been obtained.

For example, first, the specifying unit 120 extracts information representing a target from the received information representing the result, and specifies the target from the extracted information. In a case where the information for specifying the target is not extracted from the information representing the received result, the specifying unit 120 may present an instruction to input the information representing the target via the presentation unit 140. In this case, the specifying unit 120 extracts the information representing the target from the information input after the instruction to input the information representing the target is presented, and specifies the target from the extracted information.

For example, then, the specifying unit 120 may specify an individual task to be executed by the procedure in which the result is obtained, from the type of information obtained as a result and the information that is included in the knowledge DB and is obtained by the individual task. At that time, the specifying unit 120 specifies an individual task of which the received result is obtained by executing the procedure, from among individual tasks of which the procedure has been output in the past as a part of the procedure of the processing on the target and of which information representing the result is not stored in the diagnosis situation DB.

The specifying unit 120 stores the result received as the input information in the diagnosis situation DB as a result of the specified individual task.

As described above, there is a case where the above-described exchange regarding a plurality of pieces of processing on the same target is performed in parallel, procedures for the same individual task are presented in parallel as a part of each of the plurality of pieces of processing, and a result of executing the procedure is not stored in the diagnosis situation DB. In such a situation, there is a case where a result obtained by executing the procedures for the same individual task, which are presented in parallel, is input as the input information. In such a case, the specifying unit 120 may store information of a result included in the input information in the diagnosis situation DB as a result of executing the procedure for the individual task in the plurality of pieces of processing on the same target.

In a case where the input information includes the request for the procedure of processing on the target and the information representing the result obtained by executing the presented procedure, the specifying unit 120 extracts, from the input information, the request for the procedure of the processing on the target and the information representing the result obtained by executing the presented procedure. The specifying unit 120 performs an operation in a case where the above-described information representing the result obtained by executing the presented procedure is received as the input information, with respect to the extracted information representing the result obtained by executing the presented procedure. The specifying unit 120 further performs an operation in a case where the above-described request for the procedure of the processing on the target is received as the input information, with respect to the extracted request for the procedure of the processing on the target.

### Processing Information Storage Unit 121

The processing information storage unit 121 stores the above-described knowledge DB and diagnosis situation DB (in other words, information of the knowledge DB and information of the diagnosis situation DB). In other words, the processing information storage unit 121 stores information stored in the knowledge DB and information stored in the diagnosis situation DB.

### Procedure Deriving Unit 130

The procedure deriving unit 130 receives, from the specifying unit 120, a derivation instruction that instructs derivation of a procedure of executing an individual task to be executed next. As described above, the derivation instruction may be an instruction by text described using one of predetermined languages.

Upon receiving the derivation instruction, the procedure deriving unit 130 derives a procedure for executing an individual task to be executed next from information of a target, task information, order information, and result information by using the task-specific model 132 associated with the procedure deriving unit 130. At that time, upon receiving the derivation instruction, the procedure deriving unit 130 may first specify the individual task to be executed next from the task information, the order information, and the result information by using the task-specific model 132 associated with the procedure deriving unit 130. The procedure deriving unit 130 may further derive a procedure for executing the specified individual task on the target from the target information and the task information by using the task-specific model 132 associated with the procedure deriving unit 130. Here, the information of the target may be information indicating the type of the target. The task information, the order information, and the result information will be described below.

The task information includes, for example, information indicating an individual task included in a task, information indicating the type of information obtained by each individual task (referred to as individual acquisition information below), and information indicating the type of information obtained by the task (task acquisition information). The individual acquisition information is information indicating the type of information obtained from the target by executing the individual task on the target. The task acquisition information is information indicating the type of information obtained from the target by executing, on the target, all individual tasks included in the task.

The task information further includes information of a procedure for executing each individual task in various types of targets. Specifically, for each type of target, information of each procedure for executing the individual task included in the task is included. The information of the procedure is, for example, information such as a command or an operation, which represents a procedure of executing an individual task on a target. In the information of the procedure, a part in which the information indicating the target is designated may be represented by information representing a replacement target.

The task information may be stored in the task information storage unit 131 as a part of a task knowledge DB.

The order information may be information of an order represented by the task tree described above. The order information used by the procedure deriving unit 130 may be information of the order in which the individual tasks included in the task associated with the procedure deriving unit 130 are executed (that is, the above-described individual order information of the individual tasks included in the task associated with the procedure deriving unit 130).

The order information (for example, the individual order information of the individual task included in the task associated with the procedure deriving unit 130) may be given in advance to the procedure deriving unit 130. The specifying unit 120 may give (in other words, transmit) the order information to the procedure deriving unit 130. The specifying unit 120 may give (in other words, transmit), to the procedure deriving unit 130, the individual order information of the individual task included in the task associated with the procedure deriving unit 130. The procedure deriving unit 130 may read the order information stored in the processing information storage unit 121. The procedure deriving unit 130 may extract the individual order information that is information of the order in which the individual tasks included in the task associated with the procedure deriving unit 130 are executed, from the order information stored in the processing information storage unit 121.

The order information may be stored in the task information storage unit 131 as a part of the task knowledge DB.

As described above, the result information is, for example, information input as information obtained by executing a procedure of executing an individual task included in a task for implementing processing. The specifying unit 120 may give (in other words, transmit) the result information to the procedure deriving unit 130. The procedure deriving unit 130 may read the result information stored in the processing information storage unit 121.

As described above, upon receiving the derivation instruction, the procedure deriving unit 130 specifies the individual task to be executed next from the task information, the order information, and the result information by using the task-specific model 132 associated with the procedure deriving unit 130.

At that time, the procedure deriving unit 130 first specifies information of a type that is not included in the result information (referred to as task not-acquisition information below) among pieces of information indicating the type of information obtained by the task (task acquisition information). The procedure deriving unit 130 may specify information that cannot be acquired in the task acquisition information by using the result information. Specifically, for example, in a case where information of a part existing in the target and information of a part that does not exist in the target are obtained as the result information by another task that has already ended, the procedure deriving unit 130 may specify the information of the type obtained from the part existing in the target as the information of the type that can be acquired from the target. The procedure deriving unit 130 may specify information of the type obtained from the part that does not exist in the target, as the information of the type that cannot be acquired from the target. The procedure deriving unit 130 may exclude the specified type of information that cannot be acquired from the target, from the task not-acquisition information.

Specifically, for example, there is a case where the individual task is investigation of a program for causing the information processing apparatus to provide a service by using a predetermined port (for example, investigation of information including a version number), and the task not-acquisition information includes the version number of the program. The version number of the program is obtained by an individual task of investigating the version number of the program. However, there is a case where the result information includes information indicating that the predetermined port of the information processing apparatus is blocked, the information being obtained by another task. In such a case, the procedure deriving unit 130 may exclude, from the task not-acquisition information, the version number of the program that provides the service by using the predetermined port.

For example, there is a case where the individual task is an investigation of a predetermined program for which the information processing apparatus provides a service by using a predetermined port (for example, investigation of information including a version number), and the task not-acquisition information includes the version number of the predetermined program. However, there is a case where the result information includes information that is obtained by another task and indicates that the program for providing the service by using the predetermined port of the information processing apparatus is a program different from the predetermined program. In such a case, the procedure deriving unit 130 may exclude, from the task not-acquisition information, the version number of the program that provides the service by using the predetermined port.

For example, there is a case where the individual task is an investigation of a predetermined program operating in the information processing apparatus (for example, an investigation of information including a version number), and the task not-acquisition information includes the version number of the predetermined program. However, there is a case where the result information includes information that is obtained by another task and indicates that the predetermined program is not installed on the information processing apparatus. In such a case, the procedure deriving unit 130 may exclude the version number of the predetermined program from the task not-acquisition information.

There is a case where the individual task is investigation of a version number of predetermined hardware (for example, TPM; Trusted Platform Module) mounted on the information processing apparatus, and the task not-acquisition information includes the version number of the predetermined hardware. However, there is a case where the result information includes information that is obtained by another task and indicates that the predetermined hardware is not mounted on the information processing apparatus. In such a case, the procedure deriving unit 130 may exclude the version number of the predetermined hardware from the task not-acquisition information.

The procedure deriving unit 130 generates an instruction for the task-specific model 132 to derive a procedure of an individual task having the earliest execution order indicated by the order information among individual tasks for which at least a part of the above-described task not-acquisition information is obtained among individual tasks included in the task that is indicated by the task information and is associated with the procedure deriving unit 130. The procedure deriving unit 130 inputs the generated instruction to the task-specific model 132. Further, the procedure deriving unit 130 brings, back to the specifying unit 120, the procedure of executing the individual task, which is derived by the task-specific model 132, as a procedure for executing the individual task to be executed next.

The procedure deriving unit 130 may derive a procedure for executing the individual task in a plurality of stages. Specifically, for example, as described above, upon receiving the derivation instruction, the procedure deriving unit 130 may first specify the individual task to be executed next from the task information, the order information, and the result information by using the task-specific model 132 associated with the procedure deriving unit 130. The procedure deriving unit 130 may further derive a procedure for executing the specified individual task on the target from the target information and the task information by using the task-specific model 132 associated with the procedure deriving unit 130.

In this case, the procedure deriving unit 130 first generates an instruction for the task-specific model 132 to specify an individual task having the earliest execution order indicated by the order information among individual tasks for which at least a part of the above-described task not-acquisition information is obtained among individual tasks included in the task that is indicated by the task information and is associated with the procedure deriving unit 130. The procedure deriving unit 130 inputs the task information, the order information, the result information, and the generated instruction to the task-specific model 132. In accordance with the instruction, the task-specific model 132 specifies an individual task having the earliest execution order indicated by the order information among individual tasks for which at least a part of the above-described task not-acquisition information is obtained among individual tasks included in the task that is indicated by the task information and is associated with the procedure deriving unit 130. The task-specific model 132 outputs information representing the specified individual task to the procedure deriving unit 130. The procedure deriving unit 130 receives the information representing the specified individual task from the task-specific model 132. The procedure deriving unit 130 brings the received procedure information back to the specifying unit 120.

Then, the procedure deriving unit 130 generates an instruction to derive a procedure for executing the individual task with respect to the target indicated by the information of the target by using the task information including the information of the procedure of the specified individual task. The procedure deriving unit 130 inputs the information of the target, the task information, and the generated instruction to the task-specific model 132. In accordance with the received instruction, the task-specific model 132 derives a procedure for executing the individual task with respect to the target indicated by the information of the target, by using the task information including the information of the procedure for the specified individual task. The task-specific model 132 outputs information representing the derived procedure to the procedure deriving unit 130. The procedure deriving unit 130 receives the information of the derived procedure. The procedure deriving unit 130 brings the received procedure information back to the specifying unit 120.

The plurality of stages is not limited to the above example. The plurality of stages may be, for example, individual task specification for obtaining at least a part of the above-described task not-acquisition information among the individual tasks included in the task associated with the procedure deriving unit 130, specification for the individual task having the earliest execution order indicated by the order information among the specified individual tasks, and derivation of a procedure for the specified individual task.

Upon receiving the derivation instruction, the procedure deriving unit 130 may further specify the individual task to be executed next by using the history information. That is, upon receiving the derivation instruction, the procedure deriving unit 130 may first specify the individual task to be executed next from the task information, the order information, the history information, and the result information by using the task-specific model 132 associated with the procedure deriving unit 130.

The history information is information including the information of the individual task for which the procedure in the processing on the target has already been output. The history information used by the procedure deriving unit 130 may be history information of an individual task included in a task associated with the procedure deriving unit 130. The history information of the individual task included in the task associated with the procedure deriving unit 130 is information including information indicating an individual task for which the procedure has been output among individual tasks included in the task associated with the procedure deriving unit 130.

The specifying unit 120 may give (in other words, transmit) the history information to the procedure deriving unit 130. The specifying unit 120 may extract, from the history information, history information (referred to as task-specific history information below) of the individual task included in the task associated with the procedure deriving unit 130. In this case, the specifying unit 120 may give (in other words, transmit) the extracted task-specific history information to the procedure deriving unit 130. The procedure deriving unit 130 may read the history information stored in the processing information storage unit 121. The procedure deriving unit 130 may extract the history information of the individual task included in the task associated with the procedure deriving unit 130 from the history information stored in the processing information storage unit 121.

As described above, upon receiving the derivation instruction, the procedure deriving unit 130 may first specify the individual task to be executed next from the task information, the order information, the result information, and the history information by using the task-specific model 132 associated with the procedure deriving unit 130.

At that time, the procedure deriving unit 130 may generate an instruction for the task-specific model 132 to derive a procedure for an individual task that is not included in the individual task for which the procedure indicated by the history information is output and which has the earliest execution order indicated by the order information, among the individual tasks for which at least a part of the above-described task not-acquisition information is obtained, among the individual tasks included in the task that is associated with the procedure deriving unit 130 and is indicated by the task information. The procedure deriving unit 130 inputs the generated instruction to the task-specific model 132. In accordance with the instruction, the task-specific model 132 derives a procedure for an individual task that is indicated by the history information, is not included in an individual task for which the procedure is output, and has the earliest execution order indicated by the order information, among individual tasks for which at least a part of the above-described task not-acquisition information is obtained among individual tasks included in the task that is indicated by the task information and is associated with the procedure deriving unit 130. The task-specific model 132 outputs information representing the derived procedure to the procedure deriving unit 130. The procedure deriving unit 130 brings the output information representing the procedure back to the specifying unit 120.

Also in this case, the procedure deriving unit 130 may derive the procedure for the task in a plurality of stages. For example, the procedure deriving unit 130 may first generate an instruction to specify an individual task for which at least a part of the above-described task not-acquisition information is obtained among the individual tasks included in the task that is indicated by the task information and is associated with the procedure deriving unit 130. The procedure deriving unit 130 inputs the generated instruction to the task-specific model 132. The task-specific model 132 specifies the individual task in accordance with the instruction. The task-specific model 132 outputs information representing the specified individual task. For example, the procedure deriving unit 130 may then generate an instruction to exclude, from the specified individual task, the individual task for which the procedure is output and which is indicated by the history information (in other words, an instruction to specify, among the specified individual tasks, an individual task that is indicated by the history information and is not the individual task for which the procedure is output). The procedure deriving unit 130 inputs the generated instruction to the task-specific model 132. The task-specific model 132 specifies an individual task from which the individual task for which the procedure is output is excluded among the specified individual tasks in accordance with the instruction. The task-specific model 132 outputs information representing the specified individual task from which the individual task for which the procedure is output is excluded. The procedure deriving unit 130 generates an instruction to specify an individual task having the earliest execution order indicated by the order information among the specified individual tasks. The procedure deriving unit 130 inputs the generated instruction to the task-specific model 132. The task-specific model 132 specifies the individual task having the earliest execution order indicated by the order information among the specified individual tasks in accordance with the instruction. The task-specific model 132 outputs information representing the specified individual task having the earliest execution order indicated by the order information. The procedure deriving unit 130 generates an instruction to derive a procedure for executing the specified individual task with respect to the target indicated by the information of the target. The procedure deriving unit 130 inputs the generated instruction to the task-specific model 132. The task-specific model 132 derives a procedure in accordance with the instruction. The task-specific model 132 outputs information representing the derived procedure. The procedure deriving unit 130 brings the output information representing the procedure back to the specifying unit 120 as information representing a procedure for executing an individual task (that is, the target individual task) to be executed next.

The procedure deriving unit 130 may have a function of retrieval augmented generation (RAG). In that case, the procedure deriving unit 130 searches for information regarding the target task from external data (for example, data accumulated in another information processing apparatus that is communicatively connected to the execution support device 100). The procedure deriving unit 130 inputs the search data obtained by the search to the task-specific model 132 associated with the procedure deriving unit 130. After inputting the search data to the task-specific model 132, the procedure deriving unit 130 inputs an instruction to generate a procedure for an individual task to be executed next to the task-specific model 132.

### Task-Specific Model 132

The task-specific model 132 is a model to which information of a task associated with the task-specific model 132 is given and which generates a procedure for executing an individual task of the task by using the information of the task associated with the task-specific model 132.

As described above, the task-specific model 132 receives an instruction (or information and an instruction) from the procedure deriving unit 130 associated with the task-specific model 132, operates in accordance with the instruction, and outputs an operation result to the procedure deriving unit 130. In the above-described example, the instruction is specification of an individual task, derivation of a procedure for executing the individual task, and the like. In a case where the instruction is specification of the individual task, the above-described operation result is information indicating the specified individual task. In a case where the instruction is derivation of a procedure for executing the individual task, the above-described operation result is information representing the derived procedure for executing the individual task.

As described above, the procedure deriving unit 130 transmits the information indicating the procedure for the target individual task that is the individual task to be executed next to the specifying unit 120.

The procedure deriving unit 130 determines, from the task information and the result information, whether the task associated with the procedure deriving unit 130 has ended. Specifically, the procedure deriving unit 130 determines that the task associated with the procedure deriving unit 130 has ended in a case where the above-described task not-acquisition information obtained from the task information and the result information does not exist. In a case where the above-described task not-acquisition information obtained from the task information and the result information exists, the procedure deriving unit 130 determines that the task associated with the procedure deriving unit 130 does not end.

The procedure deriving unit 130 may determine whether the task associated with the procedure deriving unit 130 has ended, by using the history information. Specifically, the procedure deriving unit 130 may determine that the task associated with the procedure deriving unit 130 has ended in a case where all procedures of the individual tasks included in the task associated with the procedure deriving unit 130 are output. In this case, in a case where an individual task for which the procedure is not output exists in the individual task included in the task associated with the procedure deriving unit 130, the procedure deriving unit 130 determines that the task associated with the procedure deriving unit 130 does not end.

The procedure deriving unit 130 may determine whether the task associated with the procedure deriving unit 130 has ended from the task information, the result information, and the history information. Specifically, in a case where the above-described task not-acquisition information obtained from the task information and the result information does not exist, and in a case where all the procedures of the individual tasks included in the task associated with the procedure deriving unit 130 are output, the procedure deriving unit 130 determines that the task associated with the procedure deriving unit 130 has ended. In this case, in a case where the task not-acquisition information exists and an individual task for which the procedure is not output exists in the individual task included in the task associated with the procedure deriving unit 130, it is determined that the task associated with the procedure deriving unit 130 does not end.

The procedure deriving unit 130 may specify, as the individual task to be executed next, an individual task for which the result obtained by the output procedure is not included in the result information among the individual tasks for which the procedure is output, among the individual tasks associated with the procedure deriving unit 130. The procedure deriving unit 130 may specify an individual task for which the result obtained by output procedure is not included in the result information among the individual tasks for which the procedure is output among the individual tasks associated with the procedure deriving unit 130, by using the task-specific model 132. In this case, the procedure deriving unit 130 generates an instruction to specify an individual task for which the result obtained by the output procedure is not included in the result information among the individual tasks for which the procedure is output among the individual tasks associated with the procedure deriving unit 130. The procedure deriving unit 130 inputs the generated instruction to the task-specific model 132. In accordance with the instruction, the task-specific model 132 specifies an individual task for which the result obtained by the output procedure is not included in the result information among the individual tasks for which the procedure is output, among the individual tasks associated with the procedure deriving unit 130. In such a case where the individual task is specified, the task-specific model 132 outputs information representing the specified individual task. In a case where such an individual task has not been specified, the task-specific model 132 outputs information indicating that such an individual task has not been specified. In a case where the procedure deriving unit 130 receives information for specifying an individual task for which the result obtained by the output procedure is not included in the result information among the individual tasks for which the procedure is output among the individual tasks associated with the procedure deriving unit 130, the procedure deriving unit 130 derives a procedure for executing the individual task. Specifically, the procedure deriving unit 130 generates an instruction to derive a procedure for executing the specified individual task. The procedure deriving unit 130 inputs the generated instruction to the task-specific model 132. The task-specific model 132 generates a procedure for executing the individual task in accordance with the instruction. The task-specific model 132 outputs information representing the generated procedure to the procedure deriving unit 130. The procedure deriving unit 130 receives information representing the procedure generated by the task-specific model 132 from the task-specific model 132. The procedure deriving unit 130 brings the information that is received from the task-specific model 132 and represents the procedure, back to the specifying unit 120 as the information representing a procedure for executing an individual task to be executed next.

### Task Information Storage Unit 131

The task information storage unit 131 stores the above-described task knowledge DB (in other words, information of the task knowledge DB). In other words, the task information storage unit 131 further stores information stored in the task knowledge DB.

### Presentation Unit 140

The presentation unit 140 presents the derived procedure (in other words, information representing the derived procedure). Specifically, the presentation unit 140 may output the derived procedure to either a display of the execution support device 100 or a terminal device used by the user. The presentation unit 140 in the present example embodiment has the same function as the presentation unit 140 in the first example embodiment.

The presentation unit 140 may further present a result (that is, a result obtained by each individual task of each task included in the processing) obtained by the processing after the processing has completed (that is, after each task included in the processing has completed). In this case, the presentation unit 140 may output the result obtained by the processing to any of the display of the execution support device 100, the terminal device used by the user, and the AI that interprets information representing a procedure and executes the procedure. The output to the AI that interprets the information representing the procedure and executes the procedure represents an output as an input to the AI with respect to the information processing apparatus in which the AI operates. The presentation unit 140 may store the result obtained by the processing in any of a storage device included in the execution support device 100, a storage device that is communicatively connected to the execution support device 100, and the like.

The result obtained by the processing is, for example, information of the found vulnerability in a case where the processing is an inspection of vulnerability. The result obtained by the processing is information representing a result of design, for example, in a case where the processing is development of software. The result obtained by the processing is information representing incompleteness obtained by an inspection of a document, for example, in a case where the processing is the inspection of the document.

### Operation

Next, an operation of the second example embodiment of the present disclosure will be described in detail with reference to the drawings.

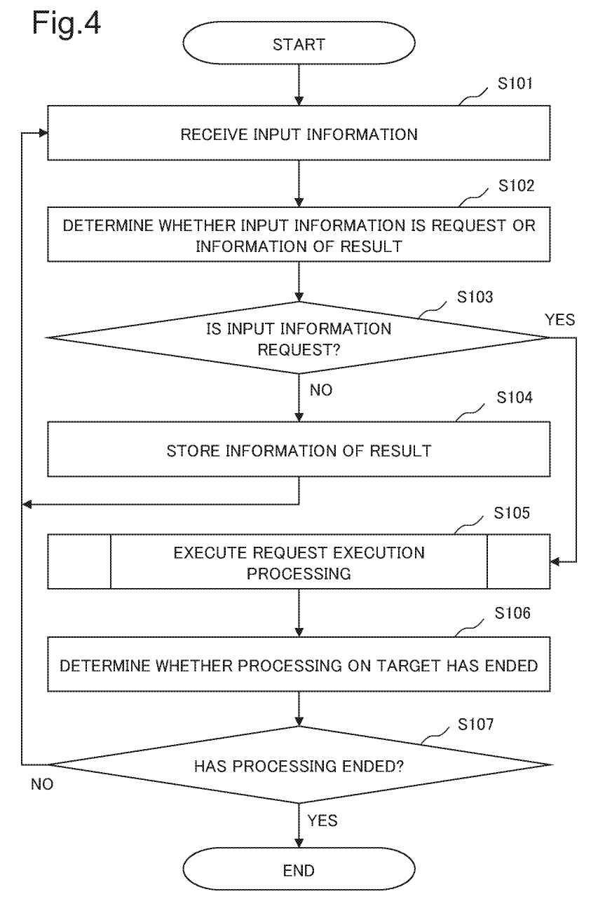

FIG. 4 is a flowchart illustrating an example of the entire operation of the execution support device according to the present disclosure.

Hereinafter, the example of the entire operation of the execution support device according to the second example embodiment of the present disclosure will be described in detail with reference to FIG. 4.

In the example illustrated in FIG. 4, first, the receiving unit 110 receives input information (Step S101).

Then, the specifying unit 120 determines whether the input information is a request or information of a result (Step S102). In a case where the input information is not the request (NO in Step S103), that is, in a case where the input information is the information of a result, the specifying unit 120 stores the input information in the processing information storage unit 121 as the information of a result (Step S104).

In a case where the input information is the request (YES in Step S103), the execution support device 100 executes request execution processing (Step S105).

After Step S105, the specifying unit 120 determines whether processing on a target has ended (Step S106). For example, in a case where all tasks for implementing the processing on the target have ended, the specifying unit 120 determines that the processing on the target has ended.

In a case where the processing on the target has not ended (NO in Step S107), the execution support device 100 repeats the operations in and after Step S101.

In a case where the processing on the target has ended (YES in Step S107), the execution support device 100 ends the operation illustrated in FIG. 4.

Before ending the operation illustrated in FIG. 4, for example, the presentation unit 140 may output all pieces of information obtained as a result to, for example, any of the display of the execution support device 100, the terminal device of the user, and the like. Before ending the operation illustrated in FIG. 4, for example, the presentation unit 140 may output a predetermined type of information among all the pieces of information obtained as the result to, for example, any one of the display of the execution support device 100, the terminal device of the user, and the like.

For example, in a case where the processing is an inspection of vulnerability, any of tasks is a task of detecting vulnerability. In a case where the vulnerability is detected, result information includes information of the detected vulnerability. The predetermined type of information may be, for example, the information of the detected vulnerability. The presentation unit 140 extracts the information of the detected vulnerability from the result information. In a case where the information of the vulnerability is extracted, the presentation unit 140 outputs the extracted information of the vulnerability. In a case where the information of the vulnerability has not been extracted, the presentation unit 140 may output information indicating that no vulnerability is detected.

In a case where the processing is development of software, the presentation unit 140 may output information representing a result of a design before the processing illustrated in FIG. 4 ends.

In a case where the processing is an inspection of a document, the presentation unit 140 may output information representing incompleteness obtained by the inspection of the document before the processing illustrated in FIG. 4 ends.

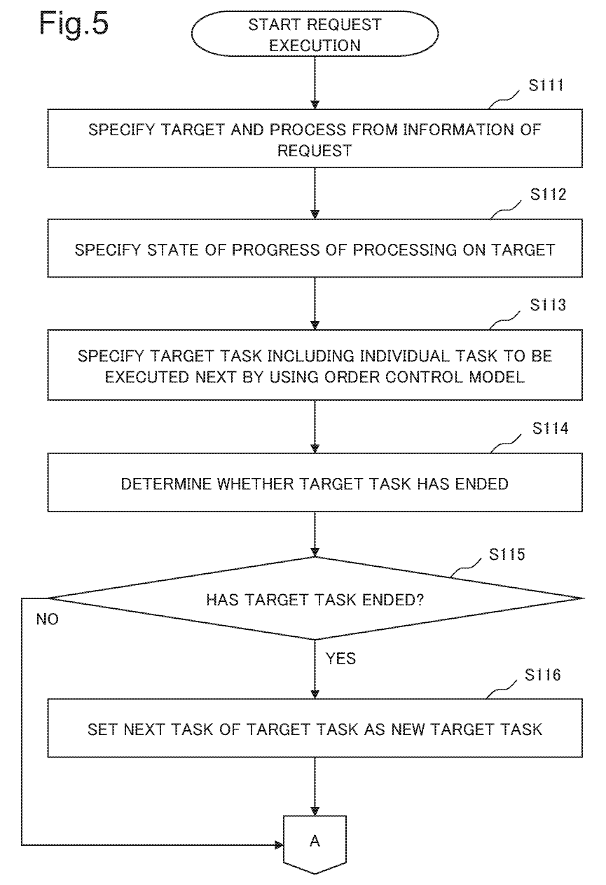

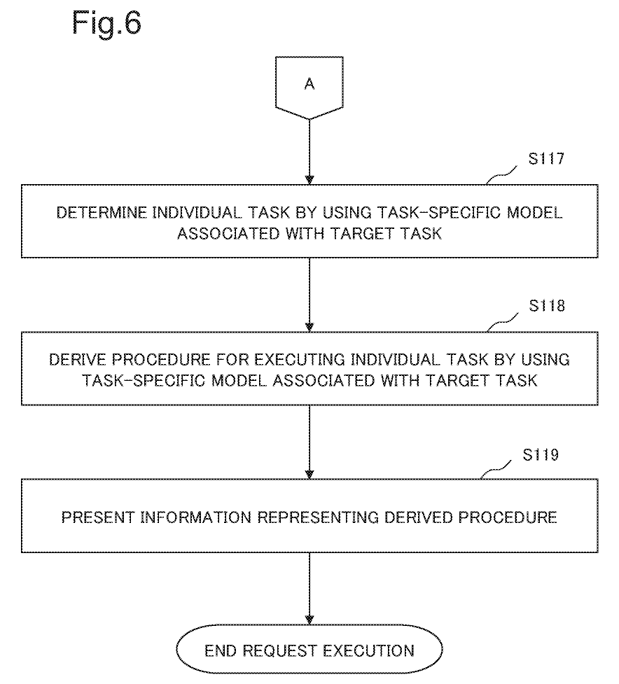

FIGS. 5 and 6 are flowcharts illustrating the example of the operation of the request execution processing of the execution support device according to the present disclosure.

Hereinafter, the operation of the request execution processing of the execution support device 100 according to the second example embodiment of the present disclosure will be described in detail with reference to FIGS. 5 and 6.

In the example illustrated in FIG. 5, first, the specifying unit 120 specifies a target and processing from information of a request (Step S111). The specifying unit 120 specifies a state of progress of processing on the target (Step S112). Specifically, the specifying unit 120 specifies the presence or absence of an ended task and the presence or absence of a task being executed among tasks for implementing the processing on the target. The specifying unit 120 further specifies a target task including an individual task to be executed next by using the order control model (Step S113).

Then, the procedure deriving unit 130 associated with the specified target task determines whether the target task has ended (Step S114). In a case where the target task does not end (NO in Step S115), the execution support device 100 then performs the operation illustrated in FIG. 6.

In a case where the target task has ended (YES in Step S115), the specifying unit 120 sets a next task of the target task as the target task (Step S116). The next task of the target task is a task to be executed next to the target task in the order information. The execution support device 100 performs the operation illustrated in FIG. 6.

In the example illustrated in FIG. 6, the procedure deriving unit 130 associated with the target task determines the individual task by using the task-specific model associated with the target task (Step S117). Then, the procedure deriving unit 130 associated with the target task derives a procedure for executing the individual task by using the task-specific model associated with the target task (Step S118). The procedure deriving unit 130 associated with the target task may input one instruction to perform the operation of Step S117 and the operation of Step S118 to the task-specific model. In other words, the procedure deriving unit 130 associated with the target task may simultaneously perform the operation of Step S117 and the operation of Step S118 by inputting one instruction to perform the operation of Step S117 and the operation of Step S118 to the task-specific model.

The presentation unit 140 presents information representing the derived procedure (Step S119).

### Effects

The present example embodiment has the same effects as the first example embodiment. The effect is achieved for the same reason that the effect of the first example embodiment is achieved.

### Modification of Second Example Embodiment

In the second example embodiment, each task includes an individual task and does not include other tasks.

However, the task may include other tasks (referred to as subtasks). The subtask may include either a subtask of the subtask or an individual task.

The procedure deriving unit 130 and the task-specific model 132 may also be assigned to and associated with the subtask. The procedure deriving unit 130 and the task-specific model 132 associated with the subtask operate similarly to the procedure deriving unit 130 and the task-specific model 132 associated with the task.

The individual order information of the task may include the information of the order for each of the individual task and the subtask included in the task. Individual order information of the subtask may include the information of the order for each of the individual task and the subtask included in the subtask. When the subtask is executed, the individual task included in the subtask or a subtask of the subtask is an individual task to be executed next or a task including the individual task to be executed next, in the order according to the individual order information of the subtask.

### Other Example Embodiments

The execution support device according to the example embodiments of the present disclosure can be implemented by a computer including a memory in which a program read from a storage medium is loaded and a processor that executes the program. The execution support device can also be implemented by dedicated hardware. The execution support device can also be implemented by a combination of the above-described computer and dedicated hardware.

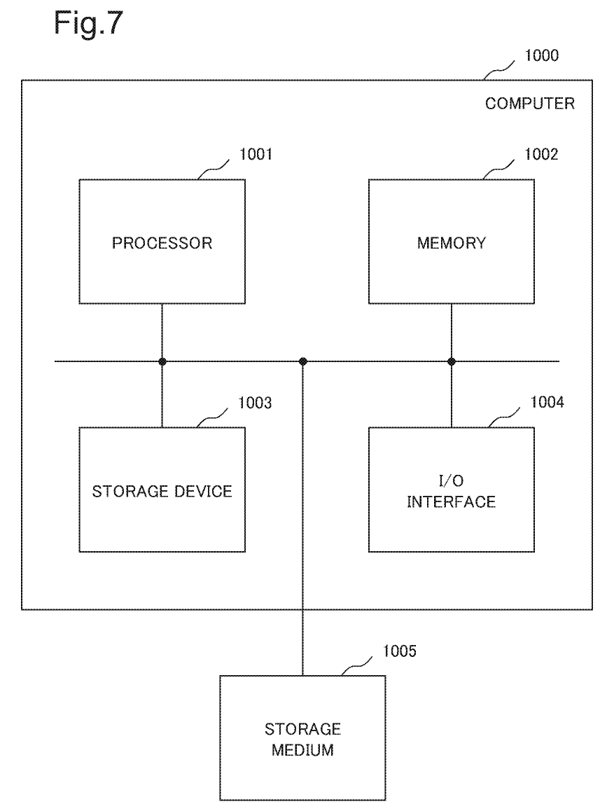

FIG. 7 is a diagram illustrating an example of a hardware configuration of a computer 1000 capable of implementing the execution support device. In the example illustrated in FIG. 7, the computer 1000 includes a processor 1001, a memory 1002, a storage device 1003, and an input/output (I/O) interface 1004. The computer 1000 can access a storage medium 1005. The memory 1002 and the storage device 1003 are storage devices such as a random access memory (RAM) and a hard disk, respectively, for example. Examples of the storage medium 1005 include a RAM, a storage device such as a hard disk, a read only memory (ROM), and a portable storage medium. The storage device 1003 may be the storage medium 1005. The processor 1001 can read and write data and programs from and to the memory 1002 and the storage device 1003. The processor 1001 can access, for example, a terminal device and a server on which the model is implemented, via the I/O interface 1004. The processor 1001 can access the storage medium 1005. The storage medium 1005 stores a program for operating the computer 1000 as the execution support device according to the example embodiments of the present disclosure.

The processor 1001 loads a program that is stored in the storage medium 1005 and causes the computer 1000 to operate as the execution support device according to the example embodiments of the present disclosure, into the memory 1002. The processor 1001 executes the program loaded in the memory 1002, whereby the computer 1000 operates as the execution support device according to the example embodiments of the present disclosure.

The receiving unit 110, the specifying unit 120, the procedure deriving unit 130, the procedure deriving unit 130A, the procedure deriving unit 130B, the procedure deriving unit 130C, and the presentation unit 140 can be implemented by, for example, the processor 1001 that executes a program loaded into the memory 1002. The order control model 122, the task-specific model 132, the task-specific model 132A, the task-specific model 132B, and the task-specific model 132C can be implemented by, for example, the processor 1001 that executes a program loaded into the memory 1002. The processing information storage unit 121, the task information storage unit 131, the task information storage unit 131A, the task information storage unit 131B, and the task information storage unit 131C can be implemented by the memory 1002 included in the computer 1000 or the storage device 1003 such as a hard disk device. Some or all of the receiving unit 110, the specifying unit 120, the processing information storage unit 121, the procedure deriving unit 130, the procedure deriving unit 130A, the procedure deriving unit 130B, the procedure deriving unit 130C, the task information storage unit 131, the task information storage unit 131A, the task information storage unit 131B, the task information storage unit 131C, and the presentation unit 140 can be implemented by dedicated circuits that implement the functions of the respective units. Some or all of the order control model 122, the task-specific model 132, the task-specific model 132A, the task-specific model 132B, and the task-specific model 132C can be implemented by dedicated circuits that implement the functions of the respective units.

Some or all of the above example embodiments may be described as the following Supplementary Notes, but are not limited to the following.

### Supplementary Note 1

An execution support device including:

receiving means for receiving a request for a procedure of processing on a target;

specifying means for specifying the target task, by using a model for specifying a target task that is a task to be performed next, from history information including information indicating a task on which execution has been completed in the processing among a plurality of tasks that implement the processing and each include an individual task and a target request that is the received request;

procedure deriving means for deriving a procedure of executing a target individual task that is an individual task to be executed next among individual tasks included in the target task, from information of the target and information of the target task, which have been already obtained; and

presentation means for presenting the procedure.

### Supplementary Note 2

The execution support device according to Supplementary Note 1, in which

the information of the target task includes individual acquisition information that is information indicating a type of information obtained by executing the procedure for the individual task included in the target task,

the receiving means receives result information that is information of the target obtained as a result of executing the presented procedure, and

the procedure deriving means determines the target individual task by using the individual acquisition information and the result information.

### Supplementary Note 3

The execution support device according to Supplementary Note 2, in which

the procedure deriving means determines the target individual task by using the result information, the individual acquisition information, and a task model capable of specifying the target individual task from the individual acquisition information and the result information.

### Supplementary Note 4

The execution support device according to Supplementary Note 1 or 2, in which

the procedure deriving means derives the procedure by using information of the target, information of the target task, and a task model capable of outputting the procedure of executing the individual task included in the target task by using the information of the target and the information of the target task.

### Supplementary Note 5

The execution support device according to Supplementary Note 2 or 3, in which

the procedure deriving means determines that the target task has ended in a case where the result information satisfies a predetermined criterion, and

in a case where it is determined that the target task has ended, the specifying means specifies, as a next target task, a task to be performed next to the target task in the processing among the plurality of tasks.

### Supplementary Note 6

The execution support device according to Supplementary Note 3, in which

a different task model is configured, for each task of the plurality of tasks, to determine the target individual task to be executed next among individual tasks included in the task, and

the procedure deriving means determines the target individual task by using the task model configured for the target task.

### Supplementary Note 7

The execution support device according to Supplementary Note 4, in which

a different task model is configured, for each task of the plurality of tasks, to derive a procedure for the target individual task to be executed next among individual tasks included in the task, and

the procedure deriving means derives the procedure for the target individual task by using the task model configured for the target task.

### Supplementary Note 8

The execution support device according to Supplementary Note 1 or 2, in which

the processing is diagnosis of security, development of software, or an inspection of a document, and

the target is at least a part of an information processing system in a case where the processing is the diagnosis of security, is at least some of source codes of the software in a case where the processing is the development of the software, and is at least a part of the document in a case where the processing is the inspection of the document.

### Supplementary Note 9

An execution support method including:

receiving a request for a procedure of processing on a target;

specifying a target task by using a model that specifies the target task that is a task to be performed next, from history information including information indicating a task on which execution has been completed in the processing among a plurality of tasks that implement the processing and each include an individual task and a target request that is the received request;

deriving a procedure of executing a target individual task that is an individual task to be executed next among individual tasks included in the target task, from information of the target and information of the target task, which have been already obtained; and

presenting the procedure.

### Supplementary Note 10

The execution support method according to Supplementary Note 9, in which

the information of the target task includes individual acquisition information that is information indicating a type of information obtained by executing the procedure for the individual task included in the target task, and

the execution support method further includes

receiving result information that is information of the target obtained as a result of executing the presented procedure, and

determining the target individual task by using the individual acquisition information and the result information.

### Supplementary Note 11

The execution support method according to Supplementary Note 10, further including:

determining the target individual task by using the result information, the individual acquisition information, and a task model capable of specifying the target individual task from the individual acquisition information and the result information.

### Supplementary Note 12

The execution support method according to Supplementary Note 9 or 10, further including:

deriving the procedure by using information of the target, information of the target task, and a task model capable of outputting the procedure of executing the individual task included in the target task by using the information of the target and the information of the target task.

### Supplementary Note 13

The execution support method according to Supplementary Note 10 or 11, further including:

determining that the target task has ended in a case where the result information satisfies a predetermined criterion; and

specifying, as a next target task, a task to be performed next to the target task in the processing among the plurality of tasks in a case where it is determined that the target task has ended.

### Supplementary Note 14

The execution support method according to Supplementary Note 11, in which

a different task model is configured, for each task of the plurality of tasks, to determine the target individual task to be executed next among individual tasks included in the task, and

the execution support method further includes determining the target individual task by using the task model configured for the target task.

### Supplementary Note 15

The execution support method according to Supplementary Note 12, in which

a different task model is configured, for each task of the plurality of tasks, to derive a procedure for the target individual task to be executed next among individual tasks included in the task, and

the execution support method further includes deriving the procedure for the target individual task by using the task model configured for the target task.

### Supplementary Note 16

The execution support method according to Supplementary Note 9 or 10, in which

the processing is diagnosis of security, development of software, or an inspection of a document, and

the target is at least a part of an information processing system in a case where the processing is the diagnosis of security, is at least some of source codes of the software in a case where the processing is the development of the software, and is at least a part of the document in a case where the processing is the inspection of the document.

### Supplementary Note 17

A program for causing a computer to execute:

a receiving process for receiving a request for a procedure of processing on a target;

a specifying process for specifying a target task by using a model that specifies the target task that is a task to be performed next, from history information including information indicating a task on which execution has been completed in the processing among a plurality of tasks that implement the processing and each include an individual task and a target request that is the received request;

a procedure deriving process for deriving a procedure of executing a target individual task that is an individual task to be executed next among individual tasks included in the target task, from information of the target and information of the target task, which have been already obtained; and

a presentation process for presenting the procedure.

### Supplementary Note 18

The program according to Supplementary Note 17, in which

the information of the target task includes individual acquisition information that is information indicating a type of information obtained by executing the procedure for the individual task included in the target task,

in the receiving process, result information that is information of the target obtained as a result of executing the presented procedure is received, and

in the procedure deriving process, the target individual task is determined by using the individual acquisition information and the result information.

### Supplementary Note 19

The program according to Supplementary Note 18, in which

in the procedure deriving process, the target individual task is determined by using the result information, the individual acquisition information, and a task model capable of specifying the target individual task from the individual acquisition information and the result information.

### Supplementary Note 20

The program according to Supplementary Note 17 or 18, in which

in the procedure deriving process, the procedure is derived by using information of the target, information of the target task, and a task model capable of outputting the procedure of executing the individual task included in the target task by using the information of the target and the information of the target task.

### Supplementary Note 21

The program according to Supplementary Note 18 or 19, in which

in the procedure deriving process, it is determined that the target task has ended in a case where the result information satisfies a predetermined criterion, and

in the specifying process, a task to be performed next to the target task in the processing among the plurality of tasks is specified as a next target task, in a case where it is determined that the target task has ended.

### Supplementary Note 22

The program according to Supplementary Note 19, in which

a different task model is configured, for each task of the plurality of tasks, to determine the target individual task to be executed next among individual tasks included in the task, and

in the procedure deriving process, the target individual task is determined by using the task model configured for the target task.

### Supplementary Note 23

The program according to Supplementary Note 20, in which

a different task model is configured, for each task of the plurality of tasks, to derive a procedure for the target individual task to be executed next among individual tasks included in the task, and

in the procedure deriving process, the procedure for the target individual task is derived by using the task model configured for the target task.

### Supplementary Note 24

The program according to Supplementary Note 17 or 18, in which

the processing is diagnosis of security, development of software, or an inspection of a document, and

the target is at least a part of an information processing system in a case where the processing is the diagnosis of security, is at least some of source codes of the software in a case where the processing is the development of the software, and is at least a part of the document in a case where the processing is the inspection of the document.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims.

What is claimed is:

1. An execution support device comprising:
at least one memory storing a set of instructions; and
at least one processor configured to execute the set of instructions to:
receive a request for a procedure of processing on a target;
specify a target task by using a model that specifies the target task, from history information and a target request that is the received request, among a plurality of tasks each of which includes an individual task, the target task being a task to be performed next, the history information including information indicating a task on which execution has been completed in the processing, the plurality of tasks achieving the processing;
derive a procedure of executing a target individual task from information of the target task and already obtained information in information of the target, the target individual task being the individual task to be executed next in the individual task included in the target task; and
present the procedure.

2. The execution support device according to claim 1, wherein
the information of the target task includes individual acquisition information that is information indicating a type of information obtained by executing the procedure of the individual task included in the target task, and
the at least one processor is further configured to execute the set of instructions to:
receive result information that is information of the target obtained as a result of executing the presented procedure; and
determine the target individual task by using the individual acquisition information and the result information.

3. The execution support device according to claim 2, wherein
the at least one processor is further configured to execute the set of instructions to determine the target individual task by using the result information, the individual acquisition information, and a task model capable of specifying the target individual task from the individual acquisition information and the result information.

4. The execution support device according to claim 1, wherein
the at least one processor is further configured to execute the set of instructions to derive the procedure by using information of the target, information of the target task, and a task model capable of outputting the procedure of executing the individual task included in the target task by using the information of the target and the information of the target task.

5. The execution support device according to claim 2, wherein
the at least one processor is further configured to execute the set of instructions to:
determine that the target task has ended in a case where the result information satisfies a predetermined criterion; and
specify, as a next target task, a task to be performed next to the target task in the processing among the plurality of tasks in a case where it is determined that the target task has ended.

6. The execution support device according to claim 3, wherein
a different task model is configured, for each task of the plurality of tasks, to determine the target individual task to be executed next in the individual task included in the task, and
the at least one processor is further configured to execute the set of instructions to determine the target individual task by using the task model configured for the target task.

7. The execution support device according to claim 4, wherein
a different task model is configured, for each task of the plurality of tasks, to derive a procedure for the target individual task to be executed next in the individual task included in the task, and
the at least one processor is further configured to execute the set of instructions to derive the procedure for the target individual task by using the task model configured for the target task.

8. The execution support device according to claim 1, wherein
the processing is diagnosis of security, development of software, or an inspection of a document, and
the target is at least a part of an information processing system in a case where the processing is the diagnosis of security, the target is at least some of source codes of the software in a case where the processing is the development of the software, and the target is at least a part of the document in a case where the processing is the inspection of the document.

9. An execution support method comprising:
receiving a request for a procedure of processing on a target;
specifying a target task by using a model that specifies the target task, from history information and a target request that is the received request, among a plurality of tasks each of which includes an individual task, the target task being a task to be performed next, the history information including information indicating a task on which execution has been completed in the processing, the plurality of tasks achieving the processing;
deriving a procedure of executing a target individual task from information of the target task and already obtained information in information of the target, the target individual task being the individual task to be executed next in the individual task included in the target task; and
presenting the procedure.

10. The execution support method according to claim 9, wherein
the information of the target task includes individual acquisition information that is information indicating a type of information obtained by executing the procedure of the individual task included in the target task, and
the execution support method further comprises:
receiving result information that is information of the target obtained as a result of executing the presented procedure; and
determining the target individual task by using the individual acquisition information and the result information.

11. The execution support method according to claim 10, further comprising
determining the target individual task by using the result information, the individual acquisition information, and a task model capable of specifying the target individual task from the individual acquisition information and the result information.

12. The execution support method according to claim 9, further comprising
deriving the procedure by using information of the target, information of the target task, and a task model capable of outputting the procedure of executing the individual task included in the target task by using the information of the target and the information of the target task.

13. The execution support method according to claim 10, further comprising:
determining that the target task has ended in a case where the result information satisfies a predetermined criterion; and
specifying, as a next target task, a task to be performed next to the target task in the processing among the plurality of tasks in a case where it is determined that the target task has ended.

14. The execution support method according to claim 11, wherein
a different task model is configured, for each task of the plurality of tasks, to determine the target individual task to be executed next in the individual task included in the task, and
execution support method further comprises determining the target individual task by using the task model configured for the target task.

15. The execution support method according to claim 12, wherein
a different task model is configured, for each task of the plurality of tasks, to derive a procedure for the target individual task to be executed next in the individual task included in the task, and
the execution support method further comprises deriving the procedure for the target individual task by using the task model configured for the target task.

16. The execution support method according to claim 9, wherein
the processing is diagnosis of security, development of software, or an inspection of a document, and
the target is at least a part of an information processing system in a case where the processing is the diagnosis of security, the target is at least some of source codes of the software in a case where the processing is the development of the software, and the target is at least a part of the document in a case where the processing is the inspection of the document.

17. A non-transitory computer readable storage medium storing a program for causing a computer to execute:
receiving processing of receiving a request for a procedure of processing on a target;
specifying processing of specifying a target task by using a model that specifies the target task that is a task to be performed next, from history information including information indicating a task on which execution has been completed in the processing among a plurality of tasks that implement the processing and each include an individual task and a target request that is the received request;
procedure deriving processing of deriving a procedure of executing a target individual task that is an individual task to be executed next among individual tasks included in the target task, from information of the target and information of the target task, which have been already obtained; and
presentation processing of presenting the procedure.

18. The non-transitory computer readable storage medium according to claim 17, wherein
the information of the target task includes individual acquisition information that is information indicating a type of information obtained by executing the procedure of the individual task included in the target task, and
the program further causes the computer to execute processing of:
receiving result information that is information of the target obtained as a result of executing the presented procedure; and
determining the target individual task by using the individual acquisition information and the result information.

19. The non-transitory computer readable storage medium according to claim 17, the program further causing the computer to execute processing of
determining the target individual task by using the result information, the individual acquisition information, and a task model capable of specifying the target individual task from the individual acquisition information and the result information.

20. The non-transitory computer readable storage medium according to claim 17, the program further causing the computer to execute processing of
deriving the procedure by using information of the target, information of the target task, and a task model capable of outputting the procedure of executing the individual task included in the target task by using the information of the target and the information of the target task.
